(19) United States
(12) Patent Application Publication
(10) Pub. No.: US 2026/0020665 A1
(43) Pub. Date: Jan. 22, 2026

(54) Hair Brush Using Artificial Intelligence and Augmented Reality for Personalization

(71) Applicant: ELC MANAGEMENT LLC, Melville, NY (US)

(72) Inventor: Christopher Aidan, Austin, TX (US)

(21) Appl. No.: 18/778,599

(22) Filed: Jul. 19, 2024

(51) Int. Cl. A46B 15/00

(52) U.S. Cl. CPC A46B 15/0002; A46B 2200/104

(57) ABSTRACT

An intelligent hairbrush device is provided. The intelligent hairbrush device includes a hairbrush housing, one or more sensors integrated within the housing, one or more processors, and one or more non-transitory memories storing computer-readable instructions. When executed by the processors, these instructions cause the processors to analyze real-time data associated with a user's hair, captured by the sensors as the user uses the intelligent hairbrush device, to determine parameters associated with the user's hair. Based on these parameters, the processors generate recommendations associated with the user's hair and provide these recommendations via a user interface.

### FIELD OF THE INVENTION

The present invention relates generally to the field of cosmetics and, more specifically, to an AI and AR integrated hairbrush that provides personalized hair care recommendations based on real-time diagnostic analysis of hair and scalp health, utilizing advanced sensor technology, machine learning algorithms, augmented reality technology, and mobile application integration.

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

Traditional hair grooming methods and tools, such as hairbrushes, often overlook individual-specific factors such as hair type, hair health, and environmental conditions, which can greatly influence the effectiveness of grooming techniques and product usage. Moreover, the lack of personalized guidance and feedback in traditional hair grooming methods often leads to suboptimal hair care routines. Users may unknowingly use products or techniques that are not suitable for their specific hair type or condition, leading to potential hair damage or unsatisfactory results. Furthermore, the current solutions in the market do not fully utilize advancements in technology to provide a more personalized, effective, and interactive hair grooming experience. For instance, while there are devices that allow for the application of hair care products, these devices are typically manually operated and do not provide precision, customization, and versatility beyond the user's baseline hair care knowledge and skills.

### SUMMARY

In one aspect, an intelligent hairbrush device is provided, comprising: a hairbrush housing; one or more sensors, integrated within the hairbrush housing, and configured to capture real-time data associated with hair of a user as the user uses the intelligent hairbrush device; one or more processors; and one or more non-transitory memories storing computer-readable instructions. The computer-readable instructions, when executed by the one or more processors, may cause the one or more processors to: analyze the real-time data associated with the hair of the user in order to determine one or more parameters associated with the hair of the user; generate, based on the one or more parameters associated with the hair of the user, one or more recommendations associated with the hair of the user; and provide the one or more recommendations via a user interface. The intelligent hairbrush device may include additional, less, or alternate elements, including those discussed elsewhere herein.

In another aspect, a computer-implemented method for controlling an intelligent hairbrush device via one or more processors is provided. The method may include receiving real-time data associated with hair of a user captured by one or more sensors, as the user uses the intelligent hairbrush device, wherein the one or more sensors are integrated within a hairbrush housing of the intelligent hairbrush device; analyzing the real-time data associated with the hair of the user in order to determine one or more parameters associated with the hair of the user; generating, based on the one or more parameters associated with the hair of the user, one or more recommendations associated with the hair of the user; and providing the one or more recommendations via a user interface. The method may include additional, less, or alternate actions, including those discussed elsewhere herein.

In still another aspect, a non-transitory computer-readable storage medium storing instructions for controlling an intelligent hairbrush device via one or more processors is provided. The computer-readable instructions, when executed by one or more processors, may cause the one or more processors to perform a method. The method may include receiving real-time data associated with hair of a user captured by one or more sensors, as the user uses the intelligent hairbrush device, wherein the one or more sensors are integrated within a hairbrush housing of the intelligent hairbrush device; analyzing the real-time data associated with the hair of the user in order to determine one or more parameters associated with the hair of the user; generating, based on the one or more parameters associated with the hair of the user, one or more recommendations associated with the hair of the user; and providing the one or more recommendations via a user interface. The instructions may direct additional, less, or alternative functionality, including that discussed elsewhere herein.

Advantages will become more apparent to those of ordinary skill in the art from the following description of the preferred embodiments which have been shown and described by way of illustration. As will be realized, the present embodiments may be capable of other and different embodiments, and their details are capable of modification in various respects. Accordingly, the drawings and description are to be regarded as illustrative in nature and not as restrictive.

### BRIEF DESCRIPTION OF THE DRAWINGS

The figures described below depict various aspects of the system and methods disclosed herein. It should be understood that each figure depicts an embodiment of a particular aspect of the disclosed system and methods, and that each of the figures is intended to accord with a possible embodiment thereof.

There are shown in the drawings arrangements which are presently discussed, it being understood, however, that the present embodiments are not limited to the precise arrangements and instrumentalities shown, wherein:

FIG. 1 depicts an exemplary computer system associated with an intelligent hairbrush device, according to some embodiments;

FIGS. 2A-2C depict examples of displays as may be provided by a user interface associated with an intelligent hairbrush device, according to some embodiments; and

FIG. 3 depicts a flow diagram of an exemplary computer-implemented method for operating an intelligent hairbrush device, according to some embodiments.

While the systems and methods disclosed herein are susceptible of being embodied in many different forms, they are shown in the drawings and are described herein in detail specific exemplary embodiments thereof, with the understanding that the present disclosure is to be considered as an exemplification of the principles of the systems and methods disclosed herein and is not intended to limit the systems and methods disclosed herein to the specific embodiments illustrated. In this respect, before explaining at least one embodiment consistent with the present systems and methods disclosed herein in detail, it is to be understood that the systems and methods disclosed herein are not limited in its application to the details of construction and to the arrangements of components set forth above and below, illustrated in the drawings, or as described in the examples.

Methods and apparatuses consistent with the systems and methods disclosed herein are capable of other embodiments and of being practiced and carried out in various ways. Also, it is to be understood that the phraseology and terminology employed herein, as well as the abstract included below, are for the purposes of description and should not be regarded as limiting.

### DETAILED DESCRIPTION

### Overview

The present disclosure introduces an intelligent hairbrush device designed to provide comprehensive hair and scalp analysis and personalized hair care recommendations. The intelligent hairbrush device may employ advanced sensor technology to evaluate various hair and scalp health parameters, such as hair porosity, elasticity, pH levels, hair density, and pore size. In conjunction with an associated mobile application, the intelligent hairbrush device may determine the user's hair type and allow users to specify their hair style preferences and desired outcomes.

The intelligent hairbrush device may utilize machine learning algorithms to analyze real-time data from the diagnostic sensors, user input interface, and a habit tracker. Based on this analysis, the intelligent hairbrush device may generate personalized hair care recommendations considering personal preferences, hair type, environmental, and lifestyle factors. The intelligent hairbrush device may also integrate seamlessly with other smart devices and employ augmented reality technology for visual feedback, enhancing the user experience.

Furthermore, the intelligent hairbrush device may include a product recommendation engine and e-commerce integration, allowing users to purchase recommended hair care products directly through the application. The intelligent hairbrush device may offer social sharing capabilities, enabling users to share their progress and recommendations on various social platforms. Additionally, the intelligent hairbrush device may provide a professional mode for hair care professionals, allowing them to monitor their client's hair health, adjust recommendations, and provide remote consultations.

Moreover, the intelligent hairbrush device's smart packaging communication feature may interact with smart packaging to enrich the user's personalized hair care recommendations. The intelligent hairbrush device may also integrate with smart mirror devices, allowing users to view their hair health data, personalized recommendations, and AR visualizations directly on the mirror while performing their hair care routine.

The intelligent hairbrush device represents a step forward in hair care by leveraging advanced sensor technology, machine learning, and user-centric design. The intelligent hairbrush device may empower users to take control of their hair health, simplify their hair care routine, and achieve their desired hair outcomes.

Furthermore, the intelligent hairbrush device offers several advantages over traditional hair grooming methods and tools. The intelligent hairbrush device provides a comprehensive, real-time analysis of the user's hair and scalp health, which may be considered a marked improvement over conventional tools that often overlook individual-specific factors such as hair type and scalp health. This enhanced capability may be achieved through the integration of advanced sensor technology within the hairbrush housing, which captures data related to hair porosity, elasticity, pH levels, hair density, and scalp health.

Moreover, the intelligent hairbrush device employs machine learning algorithms to analyze the captured data and generate personalized hair care recommendations. This represents a substantial advancement over traditional methods that lack the ability to provide personalized guidance based on the user's specific hair characteristics and goals. The intelligent hairbrush device's ability to generate recommendations based on a comprehensive set of hair, lifestyle, and environmental data sets it apart from existing solutions in the market.

Additionally, the intelligent hairbrush device enhances user experience through its user-centric design and interactive features. The integration of a user-friendly interface, augmented reality visualizer, and haptic feedback components provide a more engaging and interactive hair grooming experience. The intelligent hairbrush device also offers seamless integration with other smart devices and mobile applications, further enhancing user convenience and fostering a consistent hair care routine.

Beneficially, the intelligent hairbrush device's professional mode offers a valuable tool for hair care professionals, enabling them to monitor their client's hair health, adjust recommendations, and provide remote consultations. This feature not just enhances the level of service provided by professionals but also fosters a higher level of personalized care for clients.

Advantageously, the intelligent hairbrush device represents a substantial advancement in the field of personal care technology, offering a more scientific, personalized, and interactive approach to hair care.

### Example System

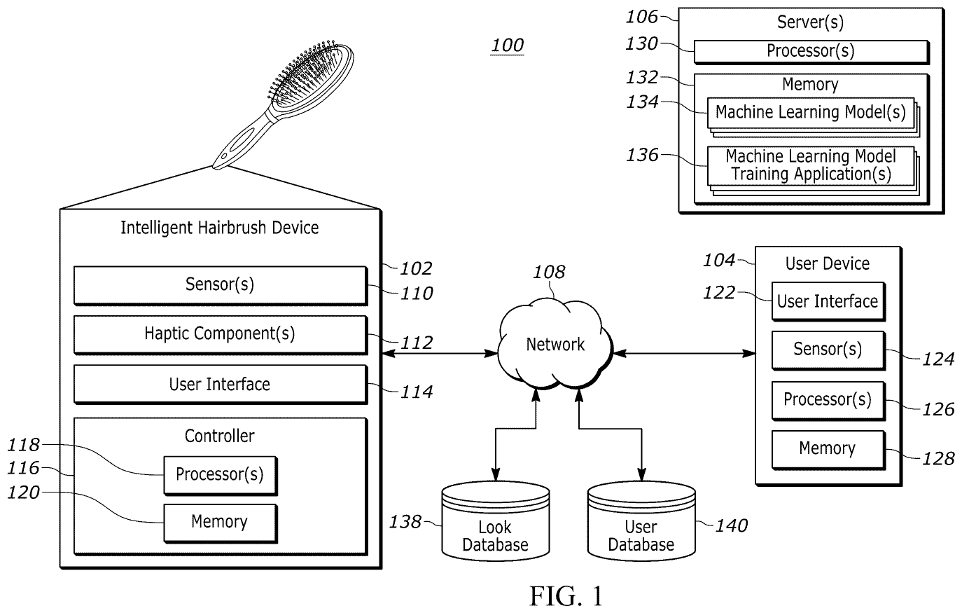

FIG. 1 depicts an exemplary computer system 100 associated with an intelligent hairbrush device 102, according to some embodiments. The high-level architecture illustrated in FIG. 1 may include both hardware and software applications, as well as various data communications channels for communicating data between the various hardware and software components, as is described below.

The exemplary intelligent hairbrush system 100 may include an intelligent hairbrush device 102 as well as, in some cases, one or more user device(s) 104 (which may include, e.g., smart phones, smart watches or fitness tracker devices, tablets, laptops, virtual reality headsets, smart or augmented reality glasses, wearables such as smart gloves, etc.), and/or one or more server(s) 106. The intelligent hairbrush device 102, user device 104, and/or server 106 may be operable to communicate with one another via a wired or wireless computer network 108, and/or via short range signals, such as BLUETOOTH signals.

Although one intelligent hairbrush device 102, one user device 104, one server 106, and one network 108 are shown in FIG. 1, various embodiments may include any number of such intelligent hairbrush devices 102, user devices 104, servers 106, and networks 108. To facilitate communications, the intelligent hairbrush device 102, user device 104, and/or server(s) 106 may each respectively comprise a wireless transceiver to receive and transmit wireless communications.

The intelligent hairbrush device 102 may be a hairbrush, comb, or other hair styling tool (such as a straightener, curling iron, etc.). The housing of the intelligent hairbrush device 102 may include one or more integrated components, such as one or more integrated sensors 110, one or more integrated haptic components 112, and/or an integrated user interface 114. Additionally, the intelligent hairbrush device 102 may include a controller 116 configured to control these components, which may include one or more processors 118, as well as one or more computer memories 120

The sensors 110 may be integrated into the housing of the intelligent hairbrush device 102 (e.g., within the bristles of a brush or comb portion of the housing of the intelligent hairbrush device), and may be operable to capture real-time data associated with the hair of a user as a user uses the intelligent hairbrush device 102, e.g., to brush or style the user's hair, or to apply one or more cosmetic products to the user's hair. The sensors 110 may include, for instance, a camera and/or a depth sensor operable to capture data associated with the user's hair (i.e., in order to determine various parameters related to the user's hair), distances from the user's hair to the intelligent hairbrush device 102, data associated with various cosmetic products to be applied to the user's hair and/or their packaging, etc. Furthermore, the sensors 110 may include ultraviolet (UV) exposure sensors configured to capture data related to UV damage (or the potential for UV damage) to the user's hair, e.g., generally or at particular dates/times. Additionally, the sensors 110 may include humidity sensors configured to capture data related to humidity levels associated with the user's hair. Moreover, the sensors 110 may include sensors (e.g., the camera and/or the depth sensor, or additional or alternative sensors) operable to capture biometric data associated with the user, such as facial recognition data, fingerprint recognition data, iris recognition data, etc. In some examples, the sensors 110 may include motion or location sensors such as accelerometers, gyroscopes, proximity sensors, etc., in order to detect the location and movement of the intelligent hairbrush device 102 with respect to the user's hair, head, and/or face.

The haptic component(s) 112 may be integrated into the housing of the intelligent hairbrush device 102 (e.g., on a handle portion of the housing of the intelligent hairbrush device 102) configured to vibrate and provide tactile and haptic feedback to the user. The haptic feedback may guide the user moving the intelligent hairbrush device 102 to the hair of the user, and/or guide the user in styling his or her hair using the intelligent hairbrush device 102, aiding the user in achieving a desired hair look and/or desired hair health goals.

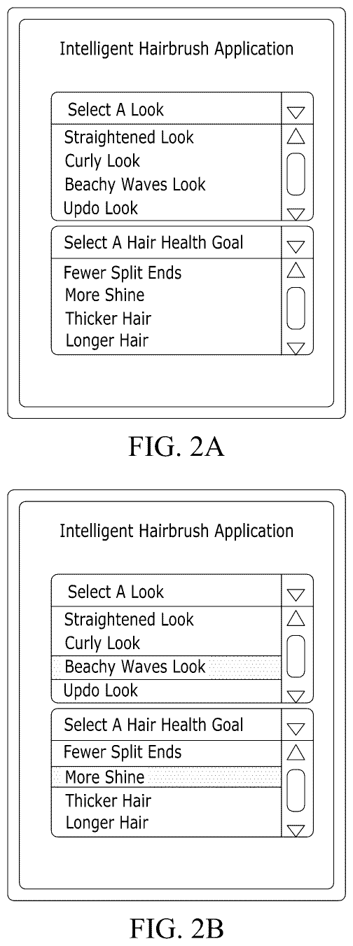

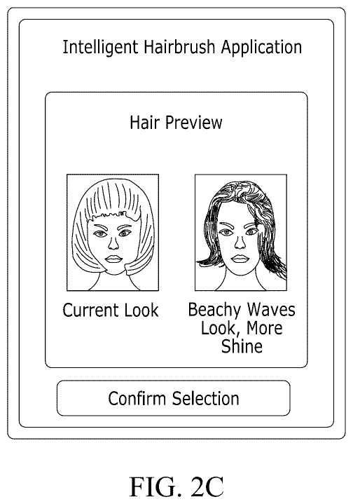

The user interface 114 may be operable to receive inputs and selections from the user of the intelligent hairbrush device 102, and/or to provide audible or visual feedback to the user of the intelligent hairbrush device 102. For instance, the user interface 114 may provide interactive displays via which users may select a desired hair look and/or hair health goal to be achieved via the intelligent hairbrush device 102. The user may select a pre-existing hair look and/or hair health goal associated with pre-existing specifications for the intelligent hairbrush device 102 to follow when guiding the user to achieve the hair look and/or hair health goal, or may customize specifications for the intelligent hairbrush device 102 to follow when guiding the user to achieve the hair look and/or hair health goal. Moreover, in some examples, the intelligent hairbrush device 102 may identify a suggested hair health goal, e.g., based on one or more detected hair health concerns or hair health conditions detected based on the sensor data. Additionally, the user may provide an image or a social media link which may be analyzed to determine the specifications for the intelligent hairbrush device 102 to follow when guiding the user to achieve the hair look and/or hair health goal. For instance, these specifications may include cosmetic products (i.e., hair products such as shampoos, conditioners, gels, mousses, sprays, masks, oils, dyes, detanglers, etc.) to be used, amounts of each cosmetic product to be used, particular techniques for applying the cosmetic products to the hair, particular hair styling techniques, etc. Examples of such displays are shown at FIGS. 2A-2C below. In some examples, the user interface component may further include an augmented reality (AR) component operable to generate and display an AR rendering of three-dimensional map of the user's hair, head, and/or face, and/or a selected hair look and/or hair health goal as applied to the user's hair. For example, in some cases, the AR rendering may be overlaid upon an image or video of the user's hair, head, and/or face as captured in real-time by the sensors 110 and/or 124, to illustrate the appearance of the selected hair look and/or hair health goal as applied to the user's hair, head, and/or face. Moreover, in some examples, the user interface 114 may be operable to receive feedback from a user associated with a selected hair look and/or hair health goal after the user's hair is styled and/or treated in accordance with the selected hair look and/or hair health goal. Furthermore, the user interface 114 may provide additional alerts, notifications, communications, etc., as discussed elsewhere herein.

The memory 120 of the intelligent hairbrush device 102 may include one or more forms of volatile and/or non-volatile, fixed and/or removable memory, such as read-only memory (ROM), electronic programmable read-only memory (EPROM), random access memory (RAM), erasable electronic programmable read-only memory (EEPROM), and/or other hard drives, flash memory, MicroSD cards, and others. The memory 120 may store an operating system (OS) (e.g., iOS, Microsoft Windows, Linux, UNIX, etc.) capable of facilitating the functionalities, apps, methods, or other software as discussed herein.

Generally speaking, the memory 120 may store instructions that, when executed by the processors 118, cause the processors 118 to receive real-time hair data from the sensors 110, analyze this data to determine parameters associated with the user's hair, and generate personalized hair care recommendations based on these parameters (e.g., via the haptic components 112 and/or the user interface 114). These recommendations may include, for example, specific hair care products, hair treatment methods, or hair styling techniques that are suitable for the user's hair type and condition.

Furthermore, the instructions, when executed by the processor(s) 118, may cause the processor(s) 118 to control the haptic components 112 (e.g., via the controller 116) to provide haptic feedback as the user uses the intelligent hairbrush device 102 to style the user's hair, and/or apply a haircare product or treatment, based on a location of the intelligent hairbrush device 102 with respect to the hair, head, and/or face of the user. For instance, the haptic components 112 may be activated to provide tactile feedback to guide the user to bring the intelligent hairbrush device 102 closer to particular areas of the user's hair (e.g., close to the part, bangs or fringe, ends, particular portions or sections of the user's hair, etc.), and/or to guide the user to style the hair or otherwise treat the hair using the intelligent hairbrush device 102, based on the determined location of the intelligent hairbrush device 102 with respect to the hair, head, and/or face of the user.

That is, the instructions stored on the memories 120 may cause the controller 116 to provide haptic feedback (e.g., via a haptic component 112) in real-time as the user holds the intelligent hairbrush device 102 to the his or her hair or head, to cause the user to hold or move the intelligent hairbrush device 102 accordance with a hair look and/or hair health goal. For instance, the instructions stored on the memories 120 may cause the controller 116 to control a haptic component 112 to provide one type of haptic feedback as the user correctly applies a recommended product to a correct portion of the user's hair using the intelligent hairbrush device 102, and another type of haptic feedback (or no haptic feedback) as the user applies an incorrect product, applies an incorrect amount of the product, applies the product to an incorrect portion of the user's hair, etc. As another example, the instructions stored on the memories 120 may cause the controller 116 to control a haptic component 112 to provide one type of haptic feedback (or to not provide haptic feedback) when the user applies a recommended styling technique associated with a desired hair look using the intelligent hairbrush device 102, and to provide another type of haptic feedback (or to provide haptic feedback) when the user uses a different technique, or when does not properly apply the technique.

Moreover, the instructions stored on the memories 120 may cause the controller 116 to adapt the haptic feedback provided by the haptic component(s) 112, based on hair conditions detected in real-time, such as hair damage, bald spots, tangles, etc., as identified in the data captured by the sensor(s) 110 of the intelligent hairbrush device 102 and/or the sensor(s) 124 of the user device 104 as the user uses the intelligent hairbrush device 102. For instance, the instructions stored on the memories 120 may cause the processors 118 to analyze image data to identify areas of concern, and may instruct the controller 116 to modify the haptic feedback provided by the haptic component(s) 112 of the intelligent hairbrush device 102 accordingly. This modification may guide the user to apply a cosmetic product with greater precision, for instance, by avoiding applying to the area of concern, or by applying additional product to areas of concern, depending on the product and they type of concern/condition.

Furthermore, in some examples, the instructions stored on the memories 120 may cause the processors 118 to analyze image data captured by the sensors 110 of the intelligent hairbrush device 102 or sensors 124 of the user device 104 to detect hair conditions of the user, and may, in some cases, cause the controller 116 to adjust or cease the guidance of the intelligent hairbrush device 102 to avoid exacerbating any detected hair conditions. Furthermore, in some examples, the instructions stored on the memories 120 may cause the processors 118 to generate an alert based on the detected hair conditions, and provide the alert, e.g., via the user interface 114 of the intelligent hairbrush device 102 and/or via the user interface 122 of the user device 104.

Furthermore, the memory 120 may store instructions that, when executed by the processors 118, cause the processors 118 to analyze images associated with cosmetic products to identify particular cosmetic products or characteristics thereof. For instance, the memory 120 may store instructions that, when executed by the processors 118, cause the processors 118 to capture image data (e.g., via the sensors 110) associated with packaging of various cosmetic products, and analyze the image data associated with the packaging of the various cosmetic products to identify respective cosmetic products based on their packaging.

For instance, in some examples, this analysis may include using object recognition techniques to identify a likely type of cosmetic product and/or likely properties associated with the cosmetic product based on the image. Moreover, in some examples, this analysis may include analyzing an image of the cosmetic product packaging using optical character recognition techniques to identify one or more letters, numbers, words, codes, etc., on the cosmetic product packaging, and accessing a database associated with cosmetic products to match any identified letters, numbers, words, codes, etc., on the cosmetic product packaging with particular cosmetic products and/or particular properties associated therewith. As another example, this analysis may include analyzing an image of the cosmetic product packaging to identify and/or decode a barcode, QR code, etc. For instance, the payload of the barcode, QR code, etc., may include an identification or indication of the cosmetic product and/or properties associated therewith.

In particular, the instructions stored on the memory 120 may cause the processors 118 to analyze real-time sensor data captured by the sensors 110 (and/or external sensors, such as sensors 124 of the user device 104) in order to generate a three-dimensional map associated with the user's hair and identify the locations of one or more hair characteristics on the three-dimensional map. The instructions stored on the memory 120 may cause the processors 118 to analyze real-time sensor data captured by the sensors 110 (and/or external sensors, such as sensors 124 of the user device 104) in order to determine the location of the intelligent hairbrush device 102 with respect to the user's hair, and may cause the controller 116 to control the haptic components 112 of the intelligent hairbrush device 102 to instruct or guide a user to apply the selected hair care routine using the intelligent hairbrush device 102, based on the determined location of the intelligent hairbrush device 102 with respect to the user's hair.

For example, the instructions stored on the memory 120 may cause the processors 118 to control the haptic components 112 to provide one type of haptic feedback when the intelligent hairbrush device 102 is maneuvered correctly to form a braid, and another type of haptic feedback when the intelligent hairbrush device 102 deviates from the braiding technique. This can guide the user to perform the hair care routine in a specific manner, such as braiding the hair in a consistent and methodical pattern.

As another example, the instructions stored on the memory 120 may cause the processors 118 to control the haptic components 112 to provide a first type of haptic feedback when the intelligent hairbrush device 102 is held too close to the scalp, a second type of haptic feedback when the intelligent hairbrush device 102 is held too far from the scalp, and a third type of haptic feedback (or the absence of haptic feedback) when the intelligent hairbrush device 102 is held at the correct distance from the scalp. This can guide the user to hold the intelligent hairbrush device 102 at the correct distance from the scalp when creating hairstyles such as ponytails or updos.

Furthermore, the instructions stored on the memory 120 may cause the processors 118 to control the haptic components 112 to provide one type of haptic feedback when the intelligent hairbrush device 102 is used to curl the correct amount of hair, and a different type of haptic feedback when too much or too little hair is being curled. This can guide the user to select the appropriate section size for desired curl tightness. Additionally, the haptic feedback may vary to instruct the user on the correct twisting or wrapping technique to achieve uniform curls or waves throughout the hair.

Additionally, the instructions stored on the memory 120 may cause the processors 118 to control the haptic components 112 to provide feedback during the application of styling products. For instance, a series of short vibrations could indicate when to start and stop spraying hairspray for setting a hairstyle, ensuring even distribution without over-application.

In the context of applying hair dye products, the instructions stored on the memory 120 may cause the processors 118 to control the haptic components 112 to guide the user through the sectioning of hair for even application of bleach or color. The haptic feedback could change patterns to signal when to move to the next section or when to apply more or less product, such as toner or glaze, to achieve a consistent color.

For the application of hair care products like deep conditioners or hair masks, the instructions stored on the memory 120 may cause the processors 118 to control the haptic components 112 to provide a pulsating feedback that corresponds with the recommended duration for massaging the product into the scalp and hair. This ensures that the user maintains the product in hair for the optimum amount of time for maximum benefit before rinsing.

Moreover, the instructions stored on the memory 120 may cause the controller 116 to adjust the movement of the intelligent hairbrush device 102 or one or more components thereof, or adjust the haptic feedback provided by the haptic components 112, based on hair conditions associated with the user's hair as detected in real-time, e.g., based on data captured by the sensors 110 of the intelligent hairbrush device 102 and/or the sensors 124 of the user device 104. For instance, the instructions stored on the memory 120 may cause the processors 118 to analyze image data captured by the sensors 110 of the intelligent hairbrush device 102 or sensors 124 of the user device 104 to detect hair conditions, and may, for instance, cause the controller 116 to adjust the movement of the intelligent hairbrush device 102 or the actuators and/or motors of the intelligent hairbrush device 102, or adjust the haptic feedback provided by the haptic components 112 of the intelligent hairbrush device 102, such that the hair conditions are addressed.

Furthermore, in some examples, the instructions stored on the memory 120 of the intelligent hairbrush device 102 may cause the processors 118 of the intelligent hairbrush device 102 to analyze image data captured by the sensors 110 of the intelligent hairbrush device 102 or sensors 124 of the user device 104 to detect hair conditions of the user, and may, in some cases, cause the controller 116 of the intelligent hairbrush device 102 to adjust or cease the movement of the intelligent hairbrush device 102 or components thereof to avoid exacerbating any of the hair conditions. Furthermore, in some examples, the instructions stored on the memory 120 of the intelligent hairbrush device 102 may cause the processors 118 of the intelligent hairbrush device 102 to generate an alert based on the detected hair conditions, and provide the alert, e.g., via the user interface 114 of the intelligent hairbrush device 102 and/or via the user interface 122 of the user device 104.

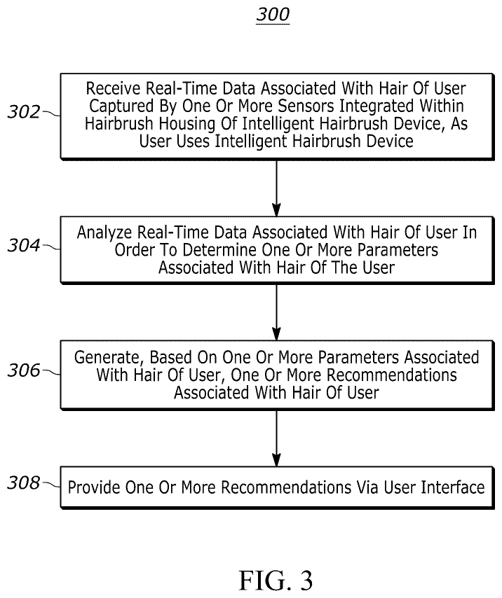

Furthermore, in some examples, the instructions stored on the memory 120 of the intelligent hairbrush device 102 may cause the processors 118 of the intelligent hairbrush device 102 and/or the controller 116 of the intelligent hairbrush device 102 to perform any or all of the steps of the method 300 discussed below with respect to FIG. 3.

The user device 104 may include, or may be operable to communicate with, a user interface 122 of the user device 104, which may receive input from users and may provide audible or visible output to users in a similar manner as discussed above with respect to the user interface 114 of the intelligent hairbrush device 102. Furthermore, the user device 104 may include, or may be operable to communicate with, one or more respective sensors 124 of the user device 104, which may include similar sensors and/or sensor functionality as discussed above with respect to the sensors 110 of the intelligent hairbrush device 102. Additionally, the user device 104 may include, or may be operable to communicate with one or more light sources (e.g., flashlights, etc.) of the user device 104.

Moreover, the user device 104 may include one or more processors 126, as well as one or more computer memories 128. The memories 128 of the user device 104 may include one or more forms of volatile and/or non-volatile, fixed and/or removable memory, such as read-only memory (ROM), electronic programmable read-only memory (EPROM), random access memory (RAM), erasable electronic programmable read-only memory (EEPROM), and/or other hard drives, flash memory, MicroSD cards, and others. The memories 128 of the user device 104 may store an operating system (OS) (e.g., iOS, Microsoft Windows, Linux, UNIX, etc.) capable of facilitating the functionalities, apps, methods, or other software as discussed herein. The memories 128 of the user device 104 may store instructions that, when executed by the processors 126 of the user device 104, cause the processors 126 of the user device 104 to receive input from a user as provided via the user interface 122 of the user device 104 (e.g., via interactive user interface display screens discussed below with respect to FIGS. 2A-2C), and send the received user input to the intelligent hairbrush device 102 (e.g., via the network 108, in some cases responsive to a request for such user input from the intelligent hairbrush device 102).

Furthermore, in some examples, the memories 128 of the user device 104 may store instructions that, when executed by the processors 126 of the user device 104, cause the processors 126 of the user device 104 to capture sensor data via one or more sensors 124 of the user device 104, in some cases responsive to a request for particular sensor data from the intelligent hairbrush device 102 and may send the captured sensor data to the intelligent hairbrush device 102.

Additionally, in some examples, the memories 128 of the user device 104 may store instructions that, when executed by the processors 126 of the user device 104, cause the processors 126 of the user device 104 to provide haptic feedback to a user via one or more haptic components of the user device 104, e.g., in a similar manner as discussed above with respect to the haptic components 112 of the intelligent hairbrush device 102.

Moreover, in some examples, the memories 128 of the user device 104 may store instructions that, when executed by the processors 126 of the user device 104 cause the processors 126 of the user device 104 to provide light to the face of the user via a light source(s) of the user device 104, in some cases responsive to a request from the intelligent hairbrush device 102 to provide light to the face of the user. In some examples, the request may include a request for particular lighting parameters, such as a particular level/intensity of light, or a particular warmth or color of light, and the processors 126 of the user device 104 may in turn cause the light source(s) of the user device 104 to provide the requested level/intensity, color, warmth, etc. of light to the face of the user.

Furthermore, in some examples, the instructions stored on the memory 128 of the user device 104 may cause the processors 126 of the user device 104 to perform any or all of the steps of the method 300 discussed below with respect to FIG. 3.

In some embodiments, the server(s) 106 may comprise one or more servers, which may include multiple, redundant, or replicated servers as part of a server farm. In further aspects, the server(s) 106 may be implemented as cloud-based servers, such as a cloud-based computing platform. For example, the server(s) 106 may be any one or more cloud-based platform(s) such as MICROSOFT AZURE, AMAZON AWS, or the like. The server(s) 106 may include one or more processors 126 of the server(s) 106 (e.g., CPUs) as well as one or more computer memories 132 of the server(s) 106.

The memories 132 of the server(s) 106 may include one or more forms of volatile and/or non-volatile, fixed and/or removable memory, such as read-only memory (ROM), electronic programmable read-only memory (EPROM), random access memory (RAM), erasable electronic programmable read-only memory (EEPROM), and/or other hard drives, flash memory, MicroSD cards, and others. The memories 132 of the server(s) 106 may store an operating system (OS) (e.g., Microsoft Windows, Linux, UNIX, etc.) capable of facilitating the functionalities, apps, methods, or other software as discussed herein.

Additionally, or alternatively, the memory 132 of the server(s) 106 may store hair look data and/or user data. The hair look data may also be stored in the look database 138 (or in multiple such databases), which may be accessible or otherwise communicatively coupled to the server(s) 106. The user data may also be stored in the user database 140 (or in multiple such databases), which may be accessible or otherwise communicatively coupled to the server(s) 106. Furthermore, in some examples, the hair look data and the user data may be stored in the same database, which may be accessible or otherwise communicatively coupled to the server(s) 106.

Furthermore, the memories 132 of the server(s) 106 may store instructions that, when executed by the processors 130 of the server(s) 106, cause the processors 130 of the server(s) 106 to receive data from various databases such as look database 138 and/or user database 140 and/or data from the intelligent hairbrush device 102 and/or the user device 104 (e.g., via the network 108). The data from the intelligent hairbrush device 102 and/or the user device 104 may include, for instance, data captured by the sensors 110 of the intelligent hairbrush device 102 and/or data captured by the sensors 124 of the user device 104, data input by a user via the user interface 114 of the intelligent hairbrush device 102 and/or data input by a user via the user interface 122 of the user device 104, etc. The instructions stored on the memories 132 of the server(s) 106, when executed by the processors 130 of the server(s) 106, may cause the processors 130 of the server(s) 106 to analyze data received from the look database 138 and/or the user database 140, and/or the intelligent hairbrush device 102 and/or the user device 104 in order to make an identification or a prediction based on the received data, and subsequently send the identification and/or prediction to the intelligent hairbrush device 102 and/or the user device 104.

Furthermore, the memory 132 of the server(s) 106 may store one or more machine learning models 134, and/or one or more respective machine learning model training applications 136. For instance, the analysis and identification and/or prediction discussed above may be based upon applying the trained machine learning models 134 to the data received from the look database 138 and/or the user database 140, and/or the intelligent hairbrush device 102 and/or the user device 104.

These machine learning models 134 may include, for instance, machine learning models 134 trained to analyze real-time hair data captured by the sensors of the intelligent hairbrush device 102 to determine parameters associated with the user's hair, a machine learning model trained to analyze images associated with hair looks and/or hair health goals to identify cosmetic products and/or techniques used to achieve the hair looks and/or hair health goals, a machine learning model trained to analyze data associated with the user's hair to identify a hair condition or hair concern associated with the user, a machine learning model trained to analyze data associated with previous hair looks and/or hair health goals selected by a user to predict additional hair looks and/or hair health goals for the user. These machine learning models 134 may be trained by machine learning model training applications 136 using training data, which may include historical data. Once trained, the machine learning models 134 can be applied to new or current data, distinct from the training data, to facilitate the determination of predictions or identifications related to this new or current data.

In some aspects, one or more machine learning models 134 may be executed on the server(s) 106, while in other aspects, one or more machine learning models 134 may be executed on a separate computing system, distinct from the server(s) 106. For example, the server(s) 106 may transmit data to a separate computing system, where trained machine learning models 134 are applied to the data. Subsequently, the separate computing system may send back a prediction or identification, based on the application of the trained machine learning models 134 to the data, to the server(s) 106. Additionally, in some cases, one or more machine learning models 134 may be trained by machine learning model training applications 136 executing on the server(s) 106, while in other cases, one or more machine learning models 134 may be trained by machine learning model training applications 136 executing on a computing system that is separate from the server(s) 106.

Whether the machine learning models 134 are trained on the server(s) 106 or on an external computing system, the machine learning models 134 may be trained by respective machine learning model training applications 136 utilizing training data, which may include historical data. Once trained, the machine learning models 134 can be applied to new or current data, distinct from the training data, to facilitate the determination of predictions and/or identifications related to this new or current data.

For example, machine learning models 134 trained to analyze data the user's hair to identify parameters thereof may be trained by machine learning model training applications 136 using training data including images of various individuals' hair and hair parameters associated with the individuals' hair. For instance, each image may be labeled to indicate hair parameters associated therewith (a hair elasticity parameter, a hair porosity parameter, a pH parameter, a hair density parameter, a hair color parameter, a hair curl parameter, a scalp health parameter, a hair type parameter, etc.), and these labeled images and/or three-dimensional maps may be used as training data. Once sufficiently trained using this training data, such machine learning models 134 may be applied to a new image and/or video associated with a user's hair, and may identify likely hair parameters of the hair of the particular user.

Furthermore, machine learning models 134 trained to generate recommendations associated with the hair of the user based on the one or more parameters associated with the hair of the user may be trained by machine learning model training applications 136 using training data including parameters associated with the hair of individuals, and corresponding successful hair products, techniques, or treatments associated with the hair of the respective individuals, labeled with respective measurements of hair health or hair style associated with the hair of the respective individuals. Once sufficiently trained using this training data, such machine learning models 134 may be applied to one or more parameters associated with the hair of a new individual, and may predict one or more hair products, techniques, or treatments likely to be successful for the new individual.

As another example, machine learning models 134 trained to analyze images associated with selected hair looks to identify hair care products and/or styling techniques used to create the selected hair looks may be trained by machine learning model training applications 136 using training data including images of individuals with various selected hair looks applied, and indications of hair care products and/or styling techniques that were used to create the selected hair looks shown in the images. For instance, an image of an individual sporting a particular selected hair look may be labeled with specific hair care products used to create the look, as well as types of devices used to create the selected hair looks, styling techniques used to create the selected hair looks, etc., and these labeled images may be used as training data. Once sufficiently trained using this training data, such machine learning models 134 may be applied to a new image, such as an image provided by a user via a user interface 114 of the intelligent hairbrush device 102 and/or a user interface 122 of the user device 104, or an image from a social media link provided by the user via the user interface 114 of the intelligent hairbrush device 102 and/or the user interface 122 of the user device 104, and may identify/predict hair care products and/or styling techniques that may be used to replicate the selected hair looks shown in the image. In some examples, the machine learning models 134 may further generate specifications to be used by the intelligent hairbrush device 102 when replicating the selected hair looks shown in the image.

Moreover, as another example, machine learning models 134 trained to analyze data associated with the user's hair to identify a hair type or hair conditions associated with the user may be trained by machine learning model training applications 136 using training data including images or other sensor data associated with various individuals' hair, and indications of characteristics associated with the various individuals' hair, as well as any hair conditions of the hair. For instance, images of individuals having various hair types may be labeled with the respective characteristics shown in each image. Similarly, images of individuals having various hair conditions may be labeled with an indication of the hair conditions, the location of visual indicators associated with the hair conditions shown in the image, etc. These labeled images may be used as training data, and once sufficiently trained using this training data, such machine learning models 134 may be applied to a new image, video, and/or three-dimensional map associated with a user's hair (e.g., an image or video captured by the sensors 110 of the intelligent hairbrush device 102, sensors 124 of the user device 104, etc., in real-time), and may identify/predict various characteristics and/or hair conditions associated with the user's hair.

Additionally, as another example, machine learning models 134 trained to analyze data associated with previous hair looks selected by a user to predict additional hair looks for the user may be trained by machine learning model training applications 136 using training data including hair looks selected by previous users, characteristics of the previous users, input/feedback (e.g., provided via the user interface 114 of the intelligent hairbrush device 102 or user interface 122 of the user device 104) from the previous users about the hair looks, once applied by the intelligent hairbrush device 102, etc. For instance, various hair looks may be labeled with indications of characteristics of users who gave positive feedback regarding the hair looks, indications of other hair looks receiving positive feedback from the same users, etc. Once sufficiently trained using this training data, such machine learning models 134 may be applied to a user, the user's characteristics, and previous hair looks selected/liked by the user, and may predict/suggest other hair looks that the user may enjoy.

In some embodiments, the machine learning models 134 may be trained to analyze data associated with the user's hair and scalp health to generate personalized hair care recommendations. For instance, the machine learning models 134 may be trained using data from a variety of sources, such as historical hair data from a multitude of users, scientific research on hair health, and expert knowledge from hair care professionals. This training data may include information on various hair types, hair conditions, scalp conditions, environmental factors, and the effectiveness of different hair care products and treatments.

Once trained, the machine learning models 134 can be applied to the real-time hair data captured by the sensors of the intelligent hairbrush device 102. For example, the machine learning models 134 may analyze the real-time hair data to determine parameters associated with the user's hair, such as hair elasticity, hair porosity, pH level, hair density, hair color, hair curl, scalp health, and hair type. Based on these parameters, the machine learning models 134 can generate personalized hair care recommendations for the user.

The recommendations generated by the machine learning models 134 may include a variety of suggestions tailored to the user's specific hair type and condition. For instance, the recommendations may include specific hair care products that are suitable for the user's hair type and condition, hair treatment methods that can improve the user's hair health, and hair styling techniques that can enhance the user's desired hair look. The recommendations may also include step-by-step guidance for achieving a hair look or a hair goal, which can be adjusted in real time based on additional data captured by the sensors as the user continues to use the intelligent hairbrush device 102.

In various aspects, the machine learning models 134 may comprise machine learning programs or algorithms that may be trained by and/or employ neural networks, which may include deep learning neural networks, or combined learning modules or programs that learn in one or more features or feature datasets in particular area(s) of interest. The machine learning programs or algorithms may also include natural language processing, semantic analysis, automatic reasoning, regression analysis, support vector machine (SVM) analysis, decision tree analysis, random forest analysis, K-Nearest neighbor analysis, naïve Bayes analysis, clustering, reinforcement learning, and/or other machine learning algorithms and/or techniques.

In some embodiments, the artificial intelligence and/or machine learning based algorithms used to train the machine learning models 134 may comprise a library or package executed on the server(s) 106 (or other computing devices not shown in FIG. 1). For example, such libraries may include the TENSORFLOW based library, the PYTORCH library, and/or the SCIKIT-LEARN Python library.

Machine learning may involve identifying and recognizing patterns in existing data (such as training a model based upon historical data) in order to facilitate making predictions or identification for subsequent data (such as using the machine learning model on new/current data order to determine a prediction or identification related to the new/current data).

Machine learning model(s) may be created and trained based upon example data (e.g., “training data”) inputs or data (which may be termed “features” and “labels”) in order to make valid and reliable predictions for new inputs, such as testing level or production level data or inputs. In supervised machine learning, a machine learning program operating on a server, computing device, or otherwise processor(s), may be provided with example inputs (e.g., “features”) and their associated, or observed, outputs (e.g., “labels”) in order for the machine learning program or algorithm to determine or discover rules, relationships, patterns, or otherwise machine learning “models” that map such inputs (e.g., “features”) to the outputs (e.g., labels), for example, by determining and/or assigning weights or other metrics to the model across its various feature categories. Such rules, relationships, or otherwise models may then be provided subsequent inputs in order for the model, executing on the server, computing device, or otherwise processor(s), to predict, based upon the discovered rules, relationships, or model, an expected output.

In unsupervised machine learning, the server, computing device, or otherwise processor(s), may be required to find its own structure in unlabeled example inputs, where, for example multiple training iterations are executed by the server, computing device, or otherwise processor(s) to train multiple generations of models until a satisfactory model, e.g., a model that provides sufficient prediction accuracy when given test level or production level data or inputs, is generated. The disclosures herein may use one or both of such supervised or unsupervised machine learning techniques.

In addition, the memories 132 of the server(s) 106 may also store additional machine-readable instructions, including any of one or more application(s), one or more software component(s), and/or one or more application programming interfaces (APIs), which may be implemented to facilitate or perform the features, functions, or other disclosures described herein, such as any methods, processes, elements, or limitations, as illustrated, depicted, or described for the various flowcharts, illustrations, diagrams, figures, and/or other disclosures herein. For instance, in some examples, the computer-readable instructions stored on the memories 132 of the server(s) 106 may include instructions for carrying out any of the steps of the method 300 shown in FIG. 3 via an algorithm executing on the processors 130 of the server(s) 106, which is described in greater detail below with respect to FIG. 3. It is to be appreciated that one or more other applications may be envisioned that are executed by the processors 130 of the server(s) 106. It is to be appreciated that given the state of advancements of mobile computing devices, any or all of the processes, functions, and steps described herein may be present together on a mobile computing device, such as the user computing device 104, or the intelligent hairbrush device 102.

### Example User Interface Displays

FIGS. 2A-2C depict exemplary user interface displays as may be provided by a user interface of the intelligent hairbrush device 102 (e.g., user interface 114 of the intelligent hairbrush device 102) and/or of an associated user device (e.g., user interface 122 of the user device 104). For instance, FIG. 2A illustrates an example user interface display via which a user may select desired hair looks and/or hair health goals, and FIG. 2B illustrates an example user interface display via which a user has already selected a desired hair look and a desired hair health goal. For instance, the user may select between pre-set options such as “Straightened Look,” “Curly Look,” “Beachy Waves Look,” “Updo Look,” etc., for hair looks, and/or “Fewer Split Ends,” “More Shine,” “Thicker Hair,” “Longer Hair,” etc., for hair health goals. In some examples, the pre-set options may differ based on, for instance, whether a user is subscribed to a hair recommendation service, or whether the user is operating the intelligent hairbrush device 102 in a “professional” mode compared to an “amateur” mode. Some of these options may include still-further options (not shown)—for instance, a user may select a specific celebrity for a “celebrity-inspired style.” Furthermore, in some examples, the user may be prompted to upload an image of a desired hair style or hair health goal, or a link to a social media post including a desired hair style or hair health goal, which may be analyzed to generate recommendations associated with the desired hair style and/or hair health goal for use by the intelligent hairbrush device 102 in achieving the desired hair style.

FIG. 2C illustrates an example preview of the look and hair health goal selected by the user as shown in FIG. 2B. In some examples, the preview may be a generalized preview, e.g., illustrating examples of other individuals to whom the hair look and/or hair health goal have been applied, or illustrating examples of a three-dimensional rendering of the hair look and/or hair health goal as applied to a three-dimensional model of the user's hair. As shown in FIG. 2C, the preview includes a rendering of the user's current look and a rendering of a prediction of how the user will look with the selected “Beachy Waves Look” and “More Shine” applied. Furthermore, as shown in FIG. 2C, the preview includes an option to confirm “Beachy Waves Look” and “More Shine” selections. Upon confirming the selections made by the user, the specifications associated with the “Beachy Waves Look” and/or the specifications associated with the “More Shine” hair health goal may be sent to the intelligent hairbrush device 102 so that the intelligent hairbrush device 102 may guide the user to style his or her hair in accordance with the “Beachy Waves Look” and/or achieve the “More Shine” hair health goal. For instance, the guidance may include product recommendations, as well as user interface displays, haptic feedback, etc., to guide the user through the steps of styling the hair in accordance with the hair look and/or achieving the hair goal.

### Example Method

FIG. 3 depicts a flow diagram of an exemplary computer-implemented method 300 for controlling an intelligent hairbrush device, according to one embodiment. One or more steps of the method 300 may be implemented as a set of instructions stored on computer-readable memories such as memories 120 of the intelligent hairbrush device 102, memories 132 of the server(s) 106, and memories 128 of the user computing device 104, and executable on one or more processors including processors 118 of the intelligent hairbrush device 102, processors 126 of the user computing device 104, and processors 130 of the server(s) 106.

The method 300 may include receiving (block 302) real-time data associated with the hair of a user as the user uses the intelligent hairbrush device 102. The real-time data associated with the hair of the user may be captured by one or more sensors integrated within the hairbrush housing of the intelligent hairbrush device 102. The real-time data associated with the hair of the user may include images of the user's hair, humidity levels, UV exposure levels, and other relevant data. The sensors may include image sensors, humidity sensors, UV exposure sensors, and other suitable sensors.

Furthermore, the method 300 may include analyzing (block 304) the real-time data associated with the hair of the user to determine one or more parameters associated with the hair of the user. These parameters may include, for instance, a hair elasticity parameter, a hair porosity parameter, a pH parameter, a hair density parameter, a hair color parameter, a hair curl parameter, a scalp health parameter, a hair type parameter, etc. In some embodiments, the analysis involves applying a trained machine learning model to the real-time data associated with the hair of the user to determine the one or more parameters associated with the hair of the user.

The method 300 may further include generating (block 306) one or more recommendations associated with the hair of the user based on the one or more parameters associated with the hair of the user. These recommendations may include product recommendations for the user's specific hair, step-by-step guidance for achieving a desired hair look or a hair health goal for the user's specific hair, etc. In some embodiments, the generation of recommendations may be further based on input from the user, such as an indication of a desired hair look or a hair goal. The generation of recommendations may also involve applying a trained machine learning model to the parameters associated with the user's hair to determine the one or more recommendations associated with the hair of the user.

The method 300 may further include providing (block 308) recommendations via a user interface associated with the intelligent hairbrush device, and/or using haptic feedback via the intelligent hairbrush device (e.g., provided via haptic components 112). The user interface may be integrated into the hairbrush housing (e.g., the user interface 114), or may be integrated into a separate mobile device (e.g., the user interface 122). The recommendations may be provided in various forms, such as audio recommendations or visual recommendations, including textual recommendations, images, videos, or interactive guides. In some embodiments, the method may also include generating a preview of the user's hair as it would appear after following the recommendations, and providing the generated preview via the user interface. In some examples, the method 300 may further include adjusting the guidance and/or recommendations provided by the user interface and/or haptic components in real time based on data captured by the sensors as the user uses the intelligent hairbrush device.

### Additional Considerations

The following additional considerations apply to the foregoing discussion. Throughout this specification, plural instances may implement operations or structures described as a single instance. Although individual operations of one or more methods are illustrated and described as separate operations, one or more of the individual operations may be performed concurrently, and nothing requires that the operations be performed in the order illustrated. These and other variations, modifications, additions, and improvements fall within the scope of the subject matter herein.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” or “some embodiments” means that a particular element, feature, structure, or characteristic described in connection with the embodiment is included in at least one embodiment. The appearances of the phrase “in one embodiment” or “in some embodiments” in various places in the specification are not necessarily all referring to the same embodiment.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of “a” or “an” is employed to describe elements and components of the embodiments herein. This is done merely for convenience and to give a general sense of the invention. This description should be read to include one or at least one and the singular also includes the plural unless it is obvious that it is meant otherwise.

Upon reading this disclosure, those of skill in the art will appreciate still additional alternative structural and functional designs for an AI and AR integrated hairbrush system that provides personalized hair care recommendations based on real-time diagnostic analysis of hair and scalp health, utilizing advanced sensor technology, machine learning algorithms, and mobile application integration, and/or systems, methods, and/or techniques associated therewith. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

### Aspects

1. An intelligent hairbrush device, comprising: a hairbrush housing; one or more sensors, integrated within the hairbrush housing, and configured to capture real-time data associated with hair of a user as the user uses the intelligent hairbrush device; one or more processors; and one or more non-transitory memories storing computer-readable instructions that, when executed by the one or more processors, cause the one or more processors to: analyze the real-time data associated with the hair of the user in order to determine one or more parameters associated with the hair of the user; generate, based on the one or more parameters associated with the hair of the user, one or more recommendations associated with the hair of the user; and provide the one or more recommendations via a user interface.

2. The intelligent hairbrush device of aspect 1, wherein the one or more sensors include image sensors.

3. The intelligent hairbrush device of any one of aspects 1 or 2, wherein the one or more sensors include humidity sensors.

4. The intelligent hairbrush device of any one of aspects 1-3, wherein the one or more sensors include ultraviolet (UV) exposure sensors.

5. The intelligent hairbrush device of any one of aspects 1-4, wherein the one or more parameters associated with the hair of the user include one or more of: a hair elasticity parameter, a hair porosity parameter, a pH parameter, a hair density parameter, a hair color parameter, a hair curl parameter, a scalp health parameter, and a hair type parameter.

6. The intelligent hairbrush device of any one of aspects 1-5, wherein the user interface is integrated into the hairbrush housing.

7. The intelligent hairbrush device of any one of aspects 1-6, wherein the user interface is integrated into a mobile device, separate from the hairbrush housing, and wherein the hairbrush housing further includes a communication interface configured to communicate with the mobile device.

8. The intelligent hairbrush device of any one of aspects 1-7, wherein the computer-readable instructions, when executed by the one or more processors, further cause the one or more processors to: receive, via the user interface, input from a user including an indication of a desired hair look; and wherein generating the one or more recommendations is further based on the input from the user.

9. The intelligent hairbrush device of any one of aspects 1-8, wherein the computer-readable instructions, when executed by the one or more processors, further cause the one or more processors to: receive, via the user interface, input from a user including an indication of a hair goal; and wherein generating the one or more recommendations is further based on the input from the user.

10. The intelligent hairbrush device of any one of aspects 1-9, wherein the one or more recommendations include a product recommendation.

11. The intelligent hairbrush device of any one of aspects 1-10, wherein the one or more recommendations include step-by-step guidance for achieving a hair look or a hair goal.

12. The intelligent hairbrush device of any one of aspects 1-11, wherein the computer-readable instructions, when executed by the one or more processors, further cause the one or more processors to adjust the step-by-step guidance in real time based on data captured by the one or more sensors as the user uses the intelligent hairbrush device.

13. The intelligent hairbrush device of any one of aspects 1-12, further comprising one or more haptic feedback components integrated within the hairbrush housing, and wherein the computer-readable instructions, when executed by the one or more processors, further cause the one or more processors to control the one or more haptic feedback components based on the step-by-step guidance.

14. The intelligent hairbrush device of any one of aspects 1-13, wherein the computer-readable instructions, when executed by the one or more processors, further cause the one or more processors to: generate a preview of the user's hair as it would appear after following the one or more recommendations; and provide the generated preview via the user interface.

15. The intelligent hairbrush device of any one of aspects 1-14, further comprising an augmented reality (AR) component operable to generate and display a three-dimensional AR version of the generated preview.

16. The intelligent hairbrush device of any one of aspects 1-15, wherein the AR component is integrated into the user interface.

17. The intelligent hairbrush device of any one of aspects 1-16, wherein the preview includes a three-dimensional preview of step-by-step guidance for achieving a hair look or a hair goal.

18. The intelligent hairbrush device of any one of aspects 1-17, wherein analyzing the real-time data associated with the hair of the user in order to determine one or more parameters associated with the hair of the user, includes applying a trained machine learning model to the real-time data associated with the hair of the user to determine the one or more parameters associated with the hair of the user.

19. The intelligent hairbrush device of any one of aspects 1-18, wherein the computer-readable instructions, when executed by the one or more processors, further cause the one or more processors to: obtain training data including sensor data associated with the hair of individuals as captured by one or more sensors, and corresponding parameters associated with the hair of the respective individuals; and train a machine learning model, using the training data, to identify one or more of one or more parameters associated with the hair of a new individual based on data associated with the hair of the new individual as captured by one or more sensors, resulting in the trained machine learning model.

20. The intelligent hairbrush device of any one of aspects 1-19, wherein the one or more sensors are further operable to capture data associated with packaging of one or more hair products, and wherein the computer-readable instructions, when executed by the one or more processors, further cause the one or more processors to analyze the data associated with the packaging of the one or more hair products to identify the one or more hair products.

21. The intelligent hairbrush device of any one of aspects 1-20, wherein identifying the one or more hair products includes determining one or more properties associated with the one or more hair products.

22. The intelligent hairbrush device of any one of aspects 1-21, wherein generating the one or more recommendations associated with the hair of the user based on the one or more parameters associated with the hair of the user includes applying a trained machine learning model to the one or more parameters associated with the hair of the user to generate the one or more recommendations associated with the hair of the user.

23. The intelligent hairbrush device of any one of aspects 1-22, wherein the computer-readable instructions, when executed by the one or more processors, further cause the one or more processors to: obtain training data including parameters associated with the hair of individuals, and corresponding hair products, techniques, or treatments associated with the hair of the respective individuals, labeled with respective measurements of hair health or hair style associated with the hair of the respective individuals; and train a machine learning model, using the training data, to predict one or more hair products, techniques, or treatments likely to be associated with hair health or hair style of a new individual based on one or more parameters associated with the hair of the new individual, resulting in the trained machine learning model.

24. A computer-implemented method for controlling an intelligent hairbrush device via one or more processors, comprising: receiving real-time data associated with hair of a user captured by one or more sensors, as the user uses the intelligent hairbrush device, wherein the one or more sensors are integrated within a hairbrush housing of the intelligent hairbrush device; analyzing the real-time data associated with the hair of the user in order to determine one or more parameters associated with the hair of the user; generating, based on the one or more parameters associated with the hair of the user, one or more recommendations associated with the hair of the user; and providing the one or more recommendations via a user interface.

25. A non-transitory computer-readable medium storing instructions for controlling an intelligent hairbrush device that, when executed by one or more processors, cause the one or more processors to perform a method comprising: receiving real-time data associated with hair of a user captured by one or more sensors, as the user uses the intelligent hairbrush device, wherein the one or more sensors are integrated within a hairbrush housing of the intelligent hairbrush device; analyzing the real-time data associated with the hair of the user in order to determine one or more parameters associated with the hair of the user; generating, based on the one or more parameters associated with the hair of the user, one or more recommendations associated with the hair of the user; and providing the one or more recommendations via a user interface.

What is claimed is:

1. An intelligent hairbrush device, comprising:
a hairbrush housing;
one or more sensors, integrated within the hairbrush housing, and configured to capture real-time data associated with hair of a user as the user uses the intelligent hairbrush device;
one or more processors; and
one or more non-transitory memories storing computer-readable instructions that, when executed by the one or more processors, cause the one or more processors to:
analyze the real-time data associated with the hair of the user in order to determine one or more parameters associated with the hair of the user;
generate, based on the one or more parameters associated with the hair of the user, one or more recommendations associated with the hair of the user; and
provide the one or more recommendations via a user interface.

2. The intelligent hairbrush device of claim 1, wherein the one or more sensors include image sensors.

3. The intelligent hairbrush device of claim 1, wherein the one or more sensors include humidity sensors.

4. The intelligent hairbrush device of claim 1, wherein the one or more sensors include ultraviolet (UV) exposure sensors.

5. The intelligent hairbrush device of claim 1, wherein the one or more parameters associated with the hair of the user include one or more of: a hair elasticity parameter, a hair porosity parameter, a pH parameter, a hair density parameter, a hair color parameter, a hair curl parameter, a scalp health parameter, and a hair type parameter.

6. The intelligent hairbrush device of claim 1, wherein the user interface is integrated into the hairbrush housing.

7. The intelligent hairbrush device of claim 1, wherein the user interface is integrated into a mobile device, separate from the hairbrush housing, and wherein the hairbrush housing further includes a communication interface configured to communicate with the mobile device.

8. The intelligent hairbrush device of claim 1, wherein the computer-readable instructions, when executed by the one or more processors, further cause the one or more processors to:
receive, via the user interface, input from a user including an indication of a desired hair look; and
wherein generating the one or more recommendations is further based on the input from the user.

9. The intelligent hairbrush device of claim 1, wherein the computer-readable instructions, when executed by the one or more processors, further cause the one or more processors to:
receive, via the user interface, input from a user including an indication of a hair goal; and
wherein generating the one or more recommendations is further based on the input from the user.

10. The intelligent hairbrush device of claim 1, wherein the one or more recommendations include a product recommendation.

11. The intelligent hairbrush device of claim 1, wherein the one or more recommendations include step-by-step guidance for achieving a hair look or a hair goal.

12. The intelligent hairbrush device of claim 11, wherein the computer-readable instructions, when executed by the one or more processors, further cause the one or more processors to adjust the step-by-step guidance in real time based on data captured by the one or more sensors as the user uses the intelligent hairbrush device.

13. The intelligent hairbrush device of claim 11, further comprising one or more haptic feedback components integrated within the hairbrush housing, and wherein the computer-readable instructions, when executed by the one or more processors, further cause the one or more processors to control the one or more haptic feedback components based on the step-by-step guidance.

14. The intelligent hairbrush device of claim 1, wherein the computer-readable instructions, when executed by the one or more processors, further cause the one or more processors to:
generate a preview of the hair of the user as it would appear after following the one or more recommendations; and
provide the generated preview via the user interface.

15. The intelligent hairbrush device of claim 14, further comprising an augmented reality (AR) component operable to generate and display a three-dimensional AR version of the generated preview.

16. The intelligent hairbrush device of claim 14, wherein the AR component is integrated into the user interface.

17. The intelligent hairbrush device of claim 14, wherein the preview includes a three-dimensional preview of step-by-step guidance for achieving a hair look or a hair goal.

18. The intelligent hairbrush device of claim 1, wherein analyzing the real-time data associated with the hair of the user in order to determine one or more parameters associated with the hair of the user, includes applying a trained machine learning model to the real-time data associated with the hair of the user to determine the one or more parameters associated with the hair of the user.

19. A computer-implemented method for controlling an intelligent hairbrush device via one or more processors, comprising:
receiving real-time data associated with hair of a user captured by one or more sensors, as the user uses the intelligent hairbrush device, wherein the one or more sensors are integrated within a hairbrush housing of the intelligent hairbrush device;
analyzing the real-time data associated with the hair of the user in order to determine one or more parameters associated with the hair of the user;
generating, based on the one or more parameters associated with the hair of the user, one or more recommendations associated with the hair of the user; and
providing the one or more recommendations via a user interface.

20. A non-transitory computer-readable medium storing instructions for controlling an intelligent hairbrush device that, when executed by one or more processors, cause the one or more processors to perform a method comprising:
receiving real-time data associated with hair of a user captured by one or more sensors, as the user uses the intelligent hairbrush device, wherein the one or more sensors are integrated within a hairbrush housing of the intelligent hairbrush device;
analyzing the real-time data associated with the hair of the user in order to determine one or more parameters associated with the hair of the user;
generating, based on the one or more parameters associated with the hair of the user, one or more recommendations associated with the hair of the user; and
providing the one or more recommendations via a user interface.
